(19) United States
(12) Patent Application Publication
(10) Pub. No.: US 2004/0089111 A1
(43) Pub. Date: May 13, 2004

(54) Ratchet tool having operation levers on two sides of the tool

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/289,277

(22) Filed: Nov. 7, 2002

(51) Int. Cl. B25B 13/46

(52) U.S. Cl. 81/63.2

(57) ABSTRACT

A ratchet tool includes a head having a hole defined therethrough for an engaging member engaged therewith and a recess is defined in an inner periphery of the hole so as to receive a pawl therein. The pawl has a toothed surface which is engaged with a toothed outer periphery of the engaging member. Two operation levers are respectively connected to two opposite sides of the tool and a torsion spring is biased between respective one of the two operation levers and a side of the pawl.

### FIELD OF THE INVENTION

The present invention relates to a ratchet tool that has two operation levers on two sides of the tool so that the user can reach the operation lever from whichever side of the tool.

### BACKGROUND OF THE INVENTION

A conventional ratchet tool generally includes a head with a ratchet mechanism received therein and an engaged member is rotatably engaged with a hole defined through the head of the tool. The ratchet mechanism includes a pawl which has toothed surface for being matched with the engaging member and can be controlled by an operation lever on a side of the tool. The user may operate the operation lever to change the effective direction for outputting a torque. Nevertheless, in some situations, the space for the tool to be inserted is limited and the operation lever at only one side of the ratchet tool could not be convenient for the user to approach.

The present invention intends to provide a ratchet tool that has two operation levers on two sides of the tool such that the user can easily and convenient to operate the operation lever from whichever side of the tool.

### SUMMARY OF THE INVENTION

In accordance with one aspect of the present invention, there is provided a ratchet tool that has an engaging member controlled by a pawl received in a recess in an inner periphery of the hole in the head. Two operation levers are connected to two sides of the pawl respectively and the two operation levers are accessed from two opposite sides of the tool.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the ratchet tool of the present invention;

FIG. 2 is an exploded view to show the ratchet tool of the present invention;

FIG. 3 shows the arrangement of the parts of the ratchet tool of the present invention;

FIGS. 4 to 6 show various types of the positions and the shapes of the operation levers of the ratchet tool of the present invention.

### DETAILED DESCRIPTION OF THE PREFERRED EMBODIMENT

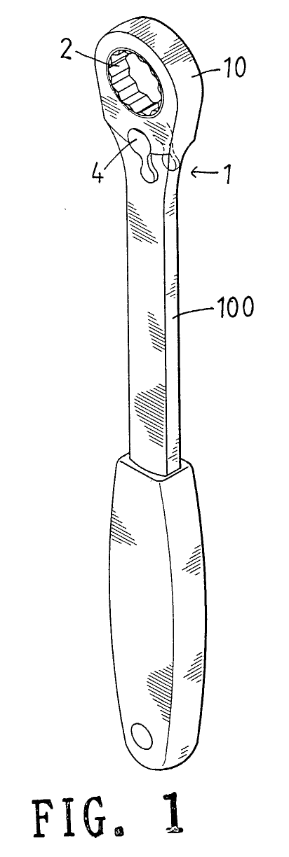

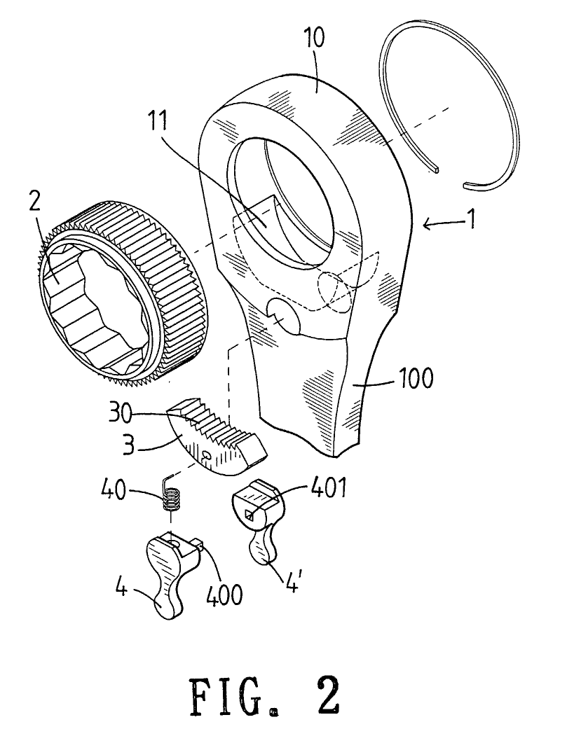

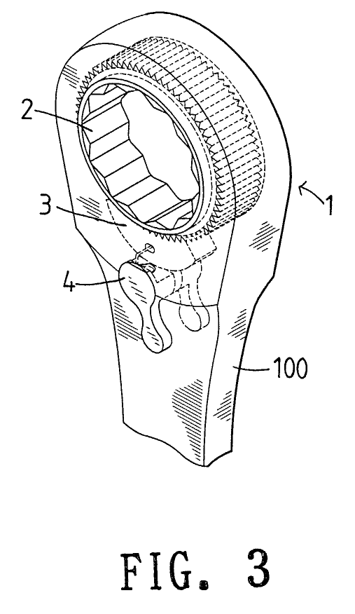

Referring to FIGS. 1 to 3, the ratchet tool 1 of the present invention comprises a head 10 having a hole defined therethrough and a recess 11 is defined in an inner periphery of the hole. A pawl 3 is pivotably received in the recess 11 and has a toothed surface 30. An engaging member 2 having a toothed outer periphery is rotatably received in the hole of the head 10 and the toothed outer periphery is engaged with the toothed surface 30 of the pawl 3.

An operation member includes two operation levers 4, 4′. One of the operation levers 4 has an insertion 400 and the other operation lever 4′ has a recess 401 for receiving the insertion 400. The operation member is received in a passage in the head 10 and the two operation levers 4, 4′ are respectively connected to two opposite sides of the tool and a torsion spring 40 is biased between the operation lever 4 and a side of the pawl 3. The two operation levers 4, 4′ can be accessed from either side of the tool and the two operation levers 4, 4′ are shifted when either one of them is shifted.

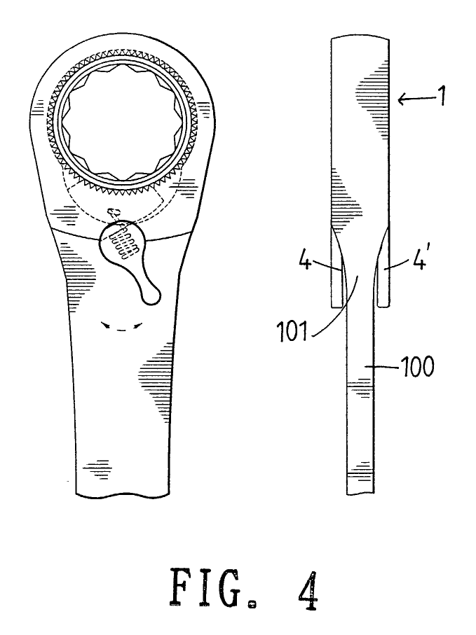

Referring to FIG. 4, a neck portion 101 is located at a conjunction portion of the head 10 and a handle 100, and the two operation levers 4, 4′ are located at two opposite sides of the neck portion 101 such that the two operation levers 4, 4′ do not protrude from the sides of the tool.

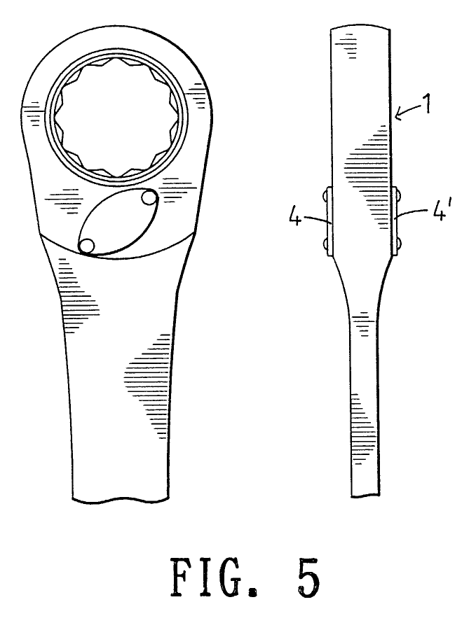

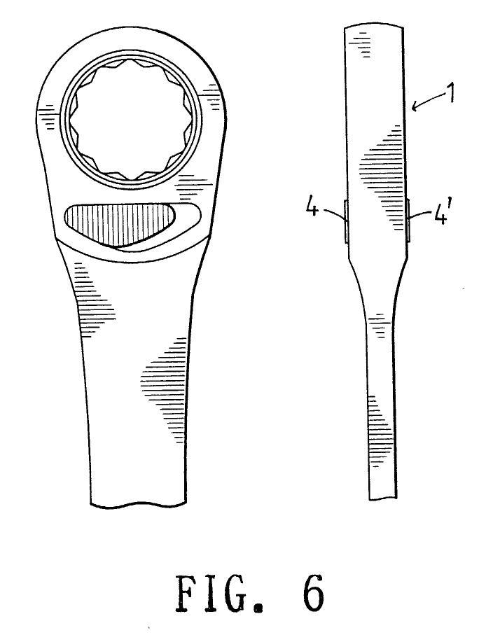

FIGS. 5 and 6 show various types of the positions and the shapes of the operation levers 4, 4′ of the ratchet tool of the present invention. The ratchet tool of the present invention allows the user to access the operation lever 4 or 4′ from whichever side of the tool.

While we have shown and described the embodiment in accordance with the present invention, it should be clear to those skilled in the art that further embodiments may be made without departing from the scope of the present invention.

What is claimed is:

1. A ratchet tool comprising:
a head having a hole defined therethrough and a recess defined in an inner periphery of the hole;
a pawl pivotably received in the recess and having a toothed surface, an engaging member rotatably received in the hole of the head and having a toothed outer periphery which is engaged with the toothed surface of the pawl, and
an operation member including two operation levers connected to the head and the two operation levers respectively connected to two opposite sides of the tool, a torsion spring biased between the operation member and a side of the pawl.

2. The tool as claimed in claim 1 further comprising a neck portion located at a conjunction portion of the head and a handle, the two operation levers located at two opposite sides of the neck portion.

3. The tool as claimed in claim 1, wherein the operation member includes two operation levers and one of which has an insertion and the other operation lever has a recess for receiving the insertion.
